(19) United States
(12) Patent Application Publication
(10) Pub. No.: US 2009/0044676 A1
(43) Pub. Date: Feb. 19, 2009

(54) POWER TILT ASSEMBLY FOR BAND SAW

(76) Inventors: James K. JOURDAN, Fond du Lac, WI (US); Clint M. Nieforth, Larsen, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/838,991

(22) Filed: Aug. 15, 2007

(51) Int. Cl. B27B 13/04

(52) U.S. Cl. 83/811

(57) ABSTRACT

A power tilt assembly for a band saw has a power tilt harp plate and a length of silent chain about the harp plate's perimeter. The chain is anchored to the harp plate at each end by a chain tensioner. The column of a blade carrying frame incorporates a tilt motor and a tilt motor shaft to drive a silent chain sprocket around a portion of which the silent chain is looped. A pair of idlers are used to maintain this portion of the silent chain in contact with the sprocket. As the tilt gear motor is actuated, the sprocket moves along the chain thereby moving the column of the blade carrying frame with it. A power tilt brake pad controls incremental movement of the column and a power tilt pointer indicates degree of tilt of the column and the corresponding angle of vertical cut to the machine operator.

### FIELD OF THE INVENTION

The present invention relates generally to vertical cut off band saw machines. More specifically, the present invention relates to vertical cut off band saw machines having blade carrying frames with power tilt capabilities. The present invention also specifically relates to a blade carrying frame tilting mechanism that is used as an improvement to vertical cut off band saw machines of current manufacture.

### BACKGROUND OF THE INVENTION

Vertical cut off band saw machines (or simply “band saws”) having blade carrying frames that tilt, and the mechanisms that are used to accomplish such tilting, are known in the art. Such tilting frame band saws can be seen, for example, in U.S. Pat. No. 4,866,630 to Beaman et al.; in U.S. Pat. No. 4,658,689 to Yakich; and in U.S. Pat. No. 6,601,494 to Jourdan. Most notably, the mechanism taught by the Jourdan patent was an improvement over prior art in that it increased the ability of the blade carrying frame of the vertical cut off band saw machine to perform “wide sweep” cutting, i.e. movement plus and minus 60° from vertical, or 120° total. It also provided means for moving the frame from one tilted position to another, rapidly and accurately.

Though fully functional and useful, the frame tilting mechanisms of the prior art still tend to be somewhat complex in design and functionality. The mechanism and improved band saw of the present invention is simple in its design and is relatively simple in its functionality. Moreover, the blade carrying frame tilting mechanism of the present invention also allows wide sweep cutting in instances where there is a large tilt movement of the frame called for by a particular sawing operation or when making a change from one operation to another. As such, the mechanism of the present invention is believed to improve over the prior art in a way that has heretofore not been devised in the art.

Accordingly, it is an object of the present invention to provide a power tilt assembly that rapidly and accurately moves the blade carrying frame of the band saw from one tilt position to another. It is another object of the present invention to provide such an assembly that allows the blade carrying frame to be tilted 60° to the left and right of vertical. It is still another object of the present invention to provide such an assembly that utilizes a minimal number of elements and a minimal number of steps to use. It is yet another object to provide such an assembly that can be used as original equipment or as a retrofit to band saws of current manufacture and design.

### SUMMARY OF THE INVENTION

The power tilt assembly of the present invention has obtained these objects. It utilizes a power tilt harp plate having an arcuate perimeter. About the perimeter of the harp plate is positioned a chain drive means. In the preferred embodiment, the chain drive means comprises a length of silent chain. The silent chain is anchored to each end of the arcuate perimeter of the harp plate by a tilt chain tensioner. The column of the blade carrying frame further incorporates a tilt gear motor and a tilt motor shaft, the tilt motor shaft being driven at one end by the tilt gear motor. At an opposing end of the tilt motor shaft is a silent chain sprocket. A portion of the silent chain is looped around a portion of the sprocket such that the sprocket can move along the length of the chain. A pair of bearings or idlers are used to maintain this portion of the silent chain in contact with the sprocket. As the tilt gear motor is actuated, the sprocket moves along the chain thereby moving the column of the blade carrying frame with it. A power tilt brake pad sub-assembly is incorporated to control incremental movement of the column as such is desired or required for a particular cutting operation. A power tilt pointer sub-assembly is also included to indicate the degree of tilt of the column and the corresponding angle of vertical cut to the machine operator.

The foregoing and other features of the power tilt assembly of the present invention will be apparent from the detailed description that follows.

### BRIEF DESCRIPTION OF THE DRAWINGS

FIG. 1 left side elevational view of a tilting frame vertical band saw employing the blade carrying frame tilting mechanism of the present invention.

FIG. 2 is an enlarged front elevational view of the blade carrying frame tilting mechanism of the present invention taken along line 2-2 of FIG. 1.

FIG. 3 is an enlarged view similar to FIG. 2 but showing the blade carrying frame tilted to the left.

FIG. 4 is a further enlarged left side elevational view of the blade carrying frame tilting mechanism of the present invention taken along line 4-4 of FIG. 2.

FIG. 5 is a further enlarged and partially sectioned left side elevational view of the blade carrying frame tilting mechanism of the present invention taken along line 5-5 of FIG. 2.

FIG. 6 is a further enlarged and partially sectioned left side elevational view of a portion of the blade carrying frame tilting mechanism of the present invention taken along line 6-6 of FIG. 5 wherein the brake is not engaged.

FIG. 7 is a view similar to FIG. 6 taken along line 7-7 of FIG. 5 wherein the brake is engaged.

### DETAILED DESCRIPTION

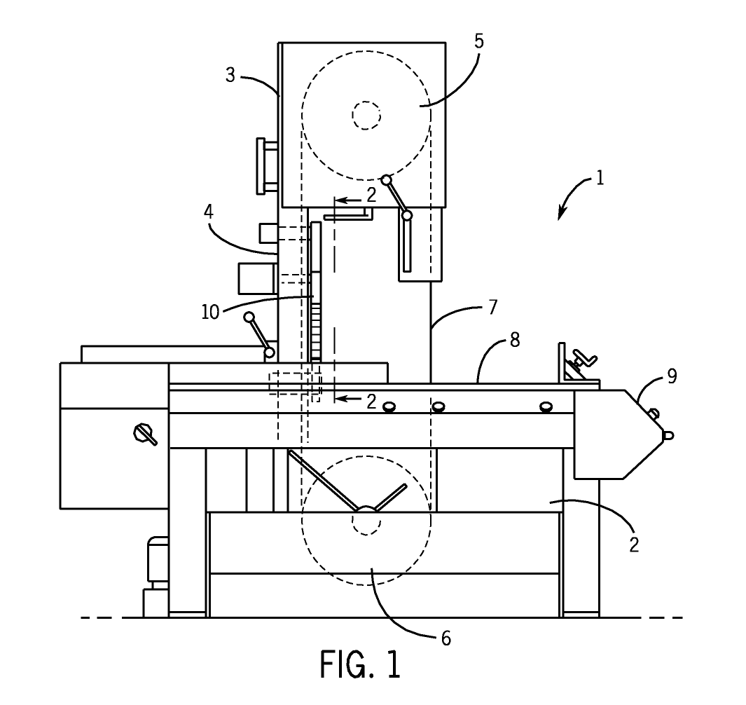

Referring now to the drawings in detail, wherein like numerals represent like structure and elements throughout, FIG. 1 illustrates a vertical cut off band saw machine, generally identified 1, of the type with which the assembly of the present invention is intended to be used. It is to be understood, however, that other similar machines could also be fitted with the apparatus of the present invention.

As shown in FIG. 1, the vertical cut off band saw machine 1 includes a base 2, the base 2 supporting a work table surface 8. Integrated within the base 2 is a blade carrying frame 3 that includes a laterally-tiltable column 4, a top band wheel 5 and a bottom band wheel 6, the top and bottom band wheels 5, 6, respectively, carrying a band saw blade 7 about them. In this fashion, a work piece (not shown) resting horizontally on the work table 8 can be cut vertically by the blade 7 as it advances forwardly across the table 8. The base 2 also includes a control panel 9 for accessing a programmable logic control (PLC) that is incorporated within the band saw machine 1, the PLC not being specifically illustrated. It is also to be understood that, as the blade carrying frame 3 and the column 4 may be tiltable at an angle relative to the vertical, any tilting of those elements necessitates the same tilt of the band saw blade 7 and to the same angle.

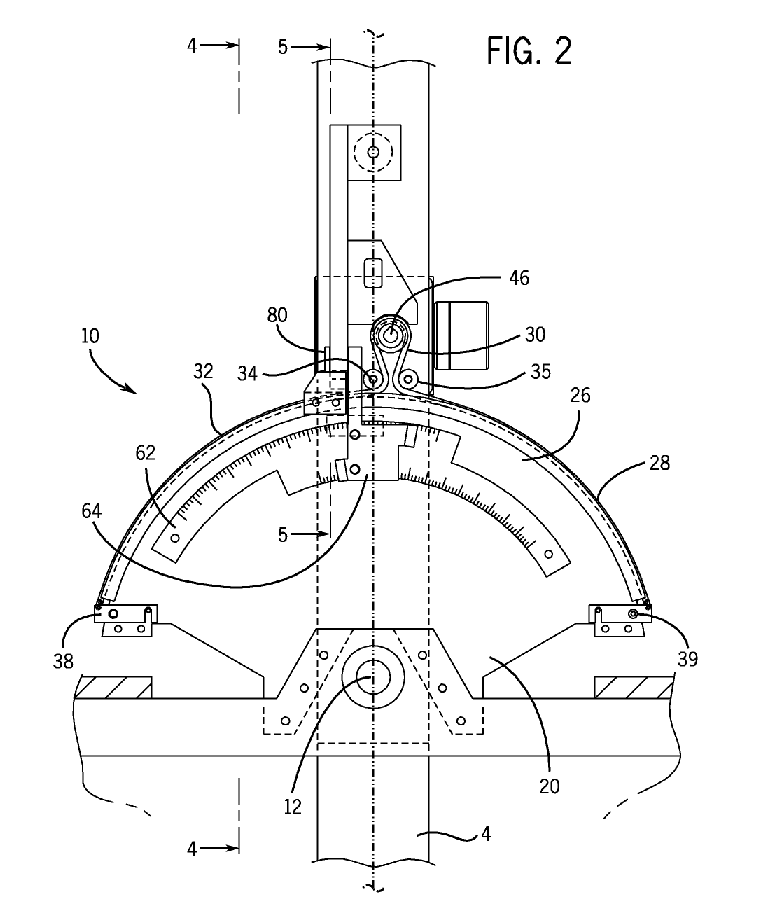

The band saw machine 1 illustrated in FIG. 1 also includes the power tilt assembly, generally identified 10, that is constructed in accordance with the present invention. Referring now to FIG. 2, the components of the preferred embodiment of the power tilt assembly 10 are illustrated in greater detail. As shown, the power tilt assembly 10 comprises a power tilt harp plate 20, the power tilt harp plate 20 comprising a substantially vertically-disposed flat fan-shaped structure having an arcuate peripheral edge 28 at the upper portion 26 of the harp plate 20. The center point of the arcuate peripheral edge 28 of the harp plate 20 coincides with the main tilt pivot bearing 12 of the column 4. The harp plate 20 is, however, a stationary structure relative to the column 4, the column being tiltable about the bearing 12.

Attached to each end of the arcuate peripheral edge 28 of the harp plate 20 is a tilt chain tensioner 38, 39, each tilt chain tensioner 38, 39 being used to anchor one end of a drive chain means 30. In the preferred embodiment, the drive chain means 30 comprises a silent chain. The silent chain 30 substantially follows and lies along the arcuate peripheral edge 28 of the harp plate 20. To maintain the lateral positioning of the chain 30 about the edge 28 of the harp plate 20, a pair of harp edge members 32 are secured to each face of the harp plate 20 at the edge 28 to form a channel-like structure at that edge 28. The silent chain 30 is typically made of stacked rows of flat, tooth shaped driving links that are configured to mesh with one or more sprockets having compatible tooth spaces, much the way a rack and pinion mesh. Typically, silent chains will also contain guide links, whose purpose is to maintain proper tracking of the chain on the sprockets. Washers or spacers may also be used in some silent chain constructions. All of these components are held together by riveted pins located in each chain joint. Although all silent chains have basic common features, there are many different styles, designs and configurations, none of which is a limitation of the present invention.

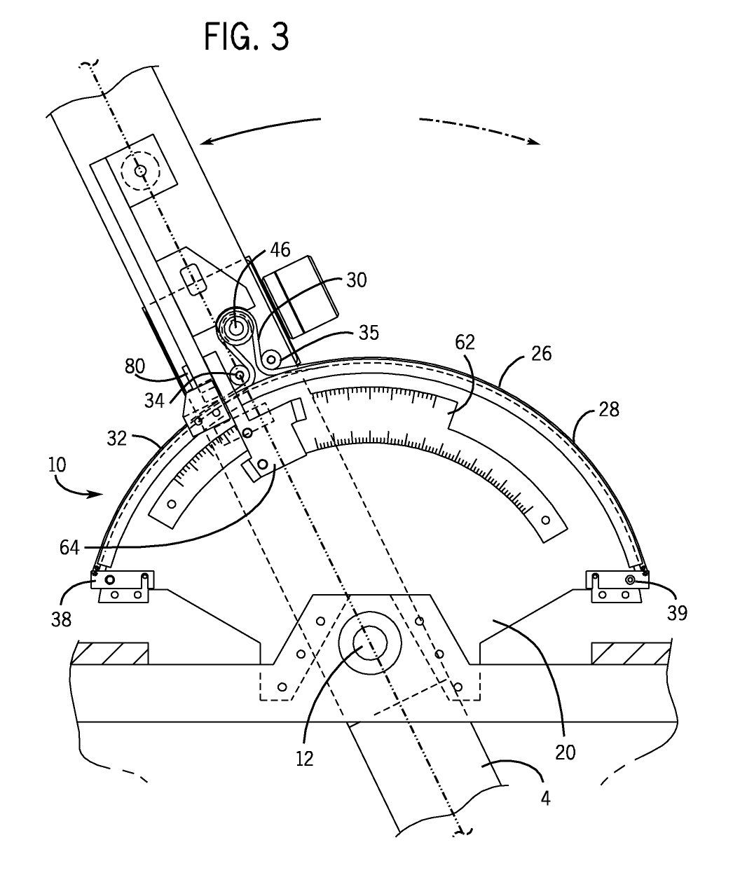

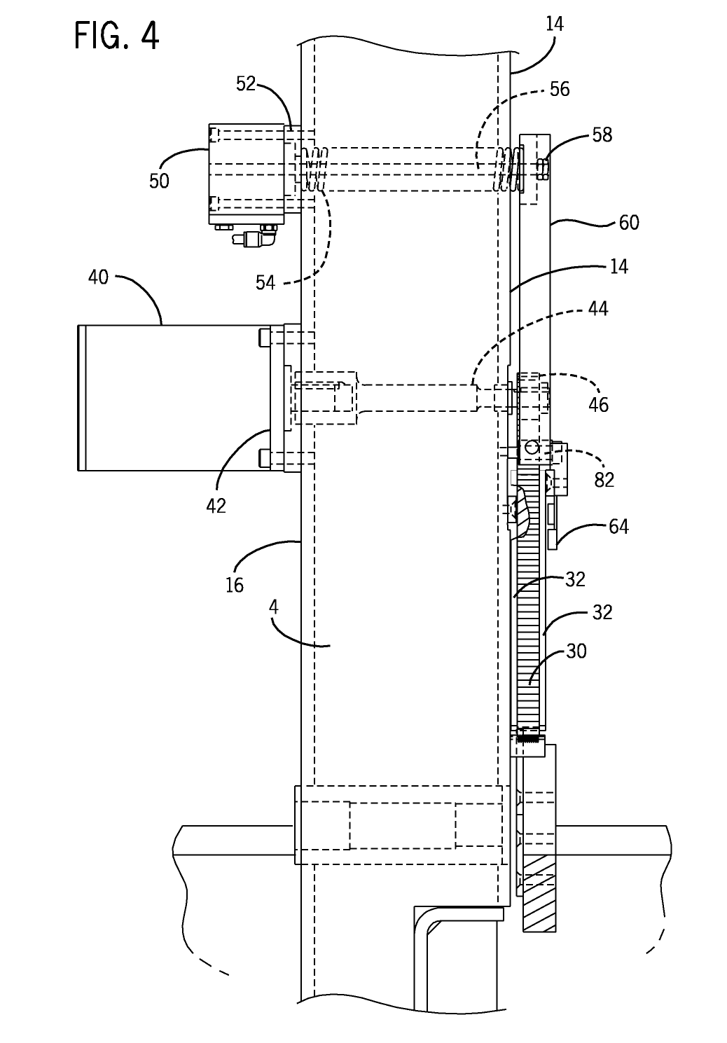

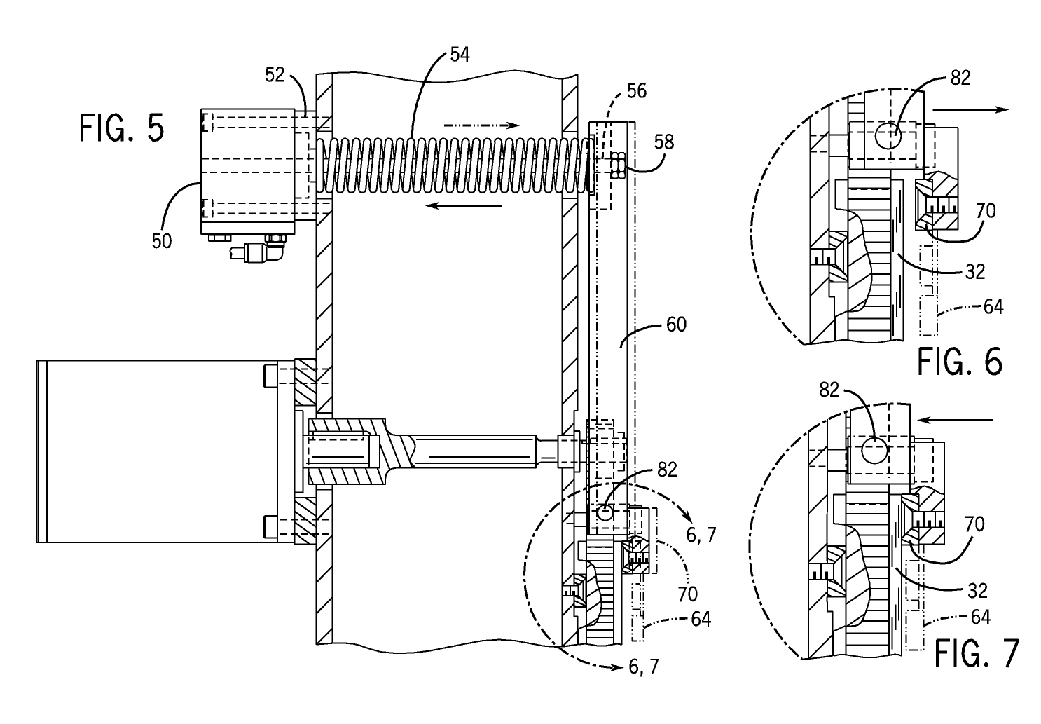

Referring to FIG. 4, it will be seen that the column 4 further includes a tilt gear motor 40 that is secured by suitable fastening means to a tilt motor adapter plate 42 that is, in turn, secured to the back face 16 of the column 4. The tilt gear motor 40 has a tilt motor shaft 44 that extends through the column 4. The tilt motor shaft 44 extends outwardly from the front face 14 of the column 4 and is attached to a silent chain sprocket 46. A portion of the silent chain 30 loops around the silent chain sprocket 46. That particular portion of the silent chain 30 is held in place by a pair of opposing idler sprockets 34, 35 that are located immediately adjacent the silent chain 30 and in proximity to the upper arcuate peripheral edge 28 of the harp plate 20. See, for example, FIG. 2. Each idler sprocket 34, 35 is retained in place by, but is also rotatable about, a shoulder bolt or other suitable fastener. It is to be understood that the silent chain 30 utilized in the preferred embodiment of the present invention allows for infinite movement of the silent chain sprocket 46 about the peripheral edge 28 of the harp plate 20. In this fashion, any angle of cut may be accomplished by movement of the chain 30 about the sprocket 46 and by the corresponding movement of the sprocket 46 about the peripheral edge 28 of the harp 20. See, for example, FIG. 3. In this application, the chain 30 itself is not longitudinally movable along that peripheral edge 28.

As previously alluded to, the band saw machine 1 and the power tilt assembly 10 of the present invention may utilize electrical signals that may be created by a programmable logic controller, or PLC (not shown), or by other suitable electronic control circuitry that is part of the controls 9 for the band saw machine 1. The PLC, or even manually actuated electrical controls, would be used to actuate the tilt gear motor 40 to move the silent chain 30 about the sprocket 46 which, in turn, moves the column 4 relative to the working surface 8 of the band saw machine 1. Again, see FIG. 3. Preferably, the silent chain 30 could be actuated to move slowly, as in a “creep mode,” or rapidly, as in a “fast mode,” depending upon the positioning sequence and accuracy desired or required. For example, the silent chain 30 could be first actuated in the “fast mode” to tilt the column 4 and the blade carrying frame 3 to a position that is generally in the range of the cut angle required and then actuated in the “creep mode” to accurately place the frame 3 and column 4 at the exact cut angle. This could be accomplished by use of a PLC or by visual and manual operator control, neither mode being a limitation of the present invention.

The power tilt assembly 10 of the present invention further includes a braking sub-assembly that comprises a tilt cylinder 50 that is secured by suitable fastening means to a tilt cylinder plate 52. The tilt cylinder plate 52 is, in turn, secured to the back face 16 of the column 4. The tilt cylinder 50 has a tilt cylinder rod 56 and tilt spring 54, both of which extend through the column 4 and project outwardly from the front face 14 of the column 4. A lever arm 60 is attached to the end of the tilt cylinder rod 56 and secured to the tilt cylinder rod 56 by a fastener 58.

The lever arm 60 has an internal clevis pin 82. The clevis pin 82 is anchored at both ends by the pivot arm weldment 80 such that the lever arm 60 provides a mechanical advantage to a brake 70. To set the brake 70, the tilt cylinder 50 is de-actuated, the tilt cylinder rod 56 is extended by the force of the tilt spring 54 and the brake 70 is set when the lever arm 60 pivots about the clevis pin 82 to press the brake 70 against the harp edge lip 32. In order to deactivate the brake 70, the tilt cylinder 50 is actuated, thereby retracting the tilt cylinder rod 56 and pivoting the lever arm 60 about the clevis pin 82 such that the brake 70 is moved away from the harp edge lip 32 such that the column 4 is permitted to rotate relative to the power tilt harp 20.

To assist the operator of the band saw 1 with proper or desired positioning of the column 4 using the power tilt assembly 10 of the present invention, the assembly 10 also includes a power tilt pointer 64 and a power tilt scale 62 which provides ruled markings such that the operator can determine the degree of tilt that the band saw machine 1 is operating at.

As disclosed above, the power tilt harp 20 is stationary. When the motor 40 is actuated, the motor 40 rotates the tiltable column 4 about the pivot tilt bearing 12. However, it is possible to instead fix the harp plate 20 to the tiltable column 4 and provide for a stationary motor (not pictured) attached to the base 2. In such an embodiment, when the motor is actuated to rotate the tiltable column 4, the motor remains stationary while the harp and tiltable column 4 are rotated together.

Based on the foregoing, it will be seen that there has been provided a new and useful means for providing a power tilting bandsaw assembly that is capable of rapidly and accurately moving the blade carrying frame of the bandsaw from one tilt position to another. An additional benefit of the claimed invention is that it can be used with new bandsaw blade machines and can be retrofitted to existing machines.

While the claimed invention has been described by reference to the example shown, the invention is not limited to the disclosed description, but on the contrary, is intended to cover various modifications and equivalent arrangements covered by the appended claims.

What is claimed is:

1. A power tilt assembly for use with a vertical cut off band saw machine, said band saw machine comprising a base and a tiltable blade carrying frame, the assembly comprising:
a power tilt harp plate fixed to the base of the band saw machine, the harp plate comprising an arcuate peripheral edge;
a chain drive means, the chain drive means being mountable about the peripheral edge of the harp plate;
a tilt gear motor, the motor being mountable to the blade-carrying frame and comprising a sprocket that is functionally adapted to cooperate with the chain drive means to tilt the blade carrying frame.

2. The power tilt assembly of claim 1 wherein the chain drive means comprises a silent chain.

3. The power tilt assembly of claim 2 wherein the silent chain is anchored at each end of the harp plate by a tilt chain tensioner.

4. The power tilt assembly of claim 1 wherein the power tilt harp plate includes a power tilt scale for determining the angle of tilt of the blade carrying frame.

5. The power tilt assembly of claim 1 wherein the blade carrying frame includes a brake assembly, the brake assembly being releasably operable to secure the blade carrying frame to the harp plate.

6. A power tilt assembly for use with a vertical cut off band saw machine, said machine comprising a blade carrying frame attached to a base by such that the blade carrying frame is permitted to tilt, the assembly comprising:
a power tilt harp plate fixed to the base, the harp plate comprising an arcuate peripheral edge;
a chain drive means, the chain drive means being secured about the peripheral edge of the harp plate; and
a tilt gear motor, the motor being mountable to the laterally tiltable column and driving a sprocket such that as the tilt gear motor is actuated, the sprocket moves along the chain thereby moving the column of the blade carrying frame to the blade carrying frame.

7. The power tilt assembly of claim 6 wherein the chain drive means comprises a silent chain.

8. The power tilt assembly of claim 7 wherein the silent chain is anchored at each end of the harp plate by a tilt chain tensioner.

9. The power tilt assembly of claim 6 wherein the power tilt harp plate includes a power tilt scale for determining the angle of tilt of the blade carrying frame.

10. The power tilt assembly of claim 6 wherein the blade carrying frame includes a brake assembly, the brake assembly being releasably operable to secure the blade carrying frame to the harp plate.

11. The power tilt assembly of claim 7 wherein a pair of idler sprockets maintain a portion of the chain in contact with the drive sprocket.

12. A power tilt assembly for use with a vertical cut off band saw machine, said machine comprising a tiltable blade carrying frame having attached to a base via a pivot bearing, the assembly comprising
a power tilt harp plate, the harp plate comprising an arcuate peripheral edge,
a chain drive means, the chain drive means being secured about the peripheral edge of the harp plate,
a tilt gear motor, the motor being mountable to the laterally tiltable column and driving a sprocket such that as the tilt gear motor is actuated, the sprocket moves along the chain thereby moving the column of the blade carrying frame to the blade carrying frame; and
a brake assembly, the brake assembly being releasably operable to secure the blade carrying frame to the harp plate.

13. The power tilt assembly of claim 12 wherein the chain drive means comprises a silent chain.

14. The power tilt assembly of claim 13 wherein the silent chain is anchored at each end of the harp plate by a tilt chain tensioner.

15. The power tilt assembly of claim 12 wherein the power tilt harp plate includes a power tilt scale for determining the angle of tilt of the blade carrying frame.

16. The power tilt assembly of claim 12 wherein a pair of idler sprockets maintain a portion of the chain in contact with the drive sprocket.
